(19) United States
(12) Patent Application Publication
(10) Pub. No.: US 2026/0185876 A1
(43) Pub. Date: Jul. 2, 2026

(54) IMAGE MEASUREMENT TOOL SYSTEMS AND METHODS

(71) Applicant: FLIR Systems AB, Täby (SE)

(72) Inventors: Johan Johansson, Täby (SE); Hans Skutberg, Täby (SE); Stefan Schulte, Vichte (BE)

(21) Appl. No.: 19/432,471

(22) Filed: Dec. 24, 2025

Related U.S. Application Data
(60) Provisional application No. 63/740,559, filed on Dec. 31, 2024.
(60) Provisional application No. 63/745,263, filed on Jan. 14, 2025.

(51) Int. Cl. G01J 5/00; G01J 5/08; G01J 5/0802; G06T 7/00; G06T 7/73

(52) U.S. Cl. CPC G01J 5/0003; G01J 5/0802; G01J 5/0859; G06T 7/001; G06T 7/74; G01J 2005/0077; G06T 2207/10048

(57) ABSTRACT

The method includes accessing a plurality of reference landmark points associated with a plurality of features in a reference image, accessing a reference measurement point corresponding to an asset in the reference image, receiving a target image including the features and the asset, identifying a plurality of target landmark points of the target image corresponding to the features, generating a mapping from the reference landmark points to the target landmark points, determining, using the mapping, a target measurement point corresponding to the asset in the target image, and extracting, from the target measurement point of the target image, a temperature measurement of the asset.

### CROSS-REFERENCE TO RELATED APPLICATIONS

This application claims the benefit of and priority to U.S. Provisional Patent Application No. 63/740,559 filed Dec. 31, 2024 and entitled “IMAGE MEASUREMENT TOOL SYSTEMS AND METHODS,” and U.S. Provisional Patent Application No. 63/745,263 filed Jan. 14, 2025 and entitled “IMAGE MEASUREMENT TOOL SYSTEMS AND METHODS,” all of which are incorporated herein by reference in their entirety.

### TECHNICAL FIELD

The present invention relates generally to asset inspection and, more particularly, to image-based inspection of assets using reference images.

### BACKGROUND

In industrial environments such as manufacturing facilities or other locations, there is often a need to inspect various assets such as machines, electronics, or other devices. In many cases, the assets may be temperature-sensitive and therefore required to operate at temperatures within expected tolerances to facilitate ongoing reliable functionality. For example, if an asset exhibits a temperature that is too high or too low, this may indicate a fault in need of repair.

Various conventional techniques exist for monitoring assets. In some cases, large numbers of sensors or fixed camera systems may be installed throughout a facility. However, such implementations can require significant investments in infrastructure and may be cost prohibitive. Moreover, the fixed nature of such implementations can limit their ability to monitor all relevant assets in a given environment. In other cases, a user may be required to manually inspect the assets. However, this approach can be subject to human error as it puts the responsibility on the user to properly monitor the condition of the asset repeatedly. Accordingly, there is a need for an improved approach to asset monitoring.

### SUMMARY

One inventive aspect is a method including accessing a plurality of reference landmark points associated with a plurality of features in a reference image, accessing a reference measurement point corresponding to an asset in the reference image, receiving a target image including the features and the asset, identifying a plurality of target landmark points of the target image corresponding to the features, generating a mapping from the reference landmark points to the target landmark points, determining, using the mapping, a target measurement point corresponding to the asset in the target image, and extracting, from the target measurement point of the target image, a temperature measurement of the asset.

In some implementations, the method also includes processing the reference image to determine the reference landmark points.

In some implementations, the method also includes receiving an input identifying the reference landmark points, and receiving an input identifying the reference measurement point.

In some implementations, the mapping is generated based on a plurality of mapping vectors that map pixel locations of the reference landmark points in the reference image to pixel locations of the target landmark points in the target image.

In some implementations, the reference image depicts the asset captured from a first point of view and the target image depicts the asset captured from a second point of view, where the mapping transforms the reference measurement point in the first point of view to the target measurement point in the second point of view.

In some implementations, the mapping includes a homography matrix.

In some implementations, the method also includes processing the target image to identify the target landmark points, and generating the mapping and determining the target measurement point in response to identifying the target landmark points.

In some implementations, the method also includes capturing the target image while moving with respect to the asset, where the target image is processed in response to the capturing.

In some implementations, the method also includes accessing one or more additional reference measurement points corresponding to the asset in the reference image, determining, using the mapping, one or more additional target measurement points corresponding to the asset in the target image, and extracting, from the one or more additional target measurement points of the target image, one or more additional temperature measurements of the asset.

In some implementations, the method also includes capturing the target image as one of a plurality of target images captured along a route.

Another inventive aspect is a system including a thermal imager, a display, and a logic device configured to access a plurality of reference landmark points associated with a plurality of features in a reference image, access a reference measurement point corresponding to an asset in the reference image, receive a target image including the features and the asset, identify a plurality of target landmark points of the target image corresponding to the features, generate a mapping from the reference landmark points to the target landmark points, determine, using the mapping, a target measurement point corresponding to the asset in the target image, and extract, from the target measurement point of the target image, a temperature measurement of the asset.

In some implementations, the logic device is further configured to process the reference image to determine the reference landmark points.

In some implementations, the logic device is further configured to receive an input identifying the reference landmark points, and to receive an input identifying the reference measurement point.

In some implementations, the mapping is generated based on a plurality of mapping vectors that map pixel locations of the reference landmark points in the reference image to pixel locations of the target landmark points in the target image.

In some implementations, the reference image depicts the asset captured from a first point of view and the target image depicts the asset captured from a second point of view, where the mapping transforms the reference measurement point in the first point of view to the target measurement point in the second point of view.

In some implementations, the mapping includes a homography matrix.

In some implementations, the logic device is further configured to process the target image to identify the target landmark points, and generate the mapping and determining the target measurement point in response to identifying the target landmark points.

In some implementations, the logic device is further configured to capture the target image while moving with respect to the asset, where the target image is processed in response to the capturing.

In some implementations, the logic device is further configured to access one or more additional reference measurement points corresponding to the asset in the reference image, determine, using the mapping, one or more additional target measurement points corresponding to the asset in the target image, and extract, from the one or more additional target measurement points of the target image, one or more additional temperature measurements of the asset.

In some implementations, the logic device is further configured to capture the target image as one of a plurality of target images captured along a route.

### BRIEF DESCRIPTION OF THE DRAWINGS

FIG. 1 illustrates a block diagram of an imaging system and a remote system according to some embodiments.

FIG. 2 illustrates a process of monitoring assets according to some embodiments.

FIG. 3 illustrates asset inspection instructions according to some embodiments.

FIG. 4 illustrates a process of determining a target measurement point according to some embodiments.

FIG. 5A illustrates a thermal image of a reference asset having a reference measurement tool according to some embodiments.

FIG. 5B illustrates a thermal image of a target asset having a target measurement tool according to some embodiments.

FIG. 6 illustrates a thermal image of an asset having a plurality of measurement tools according to some embodiments.

FIG. 7 illustrates a thermal image of a reference asset having reference landmark points, a target asset having target landmark points, and a plurality of mapping vectors according to some embodiments.

FIG. 8 illustrates a process of performing analysis on image data according to some embodiments.

Embodiments of the present invention and their advantages are best understood by referring to the detailed description that follows. It should be appreciated that like reference numerals are used to identify like elements illustrated in one or more of the figures.

### DETAILED DESCRIPTION

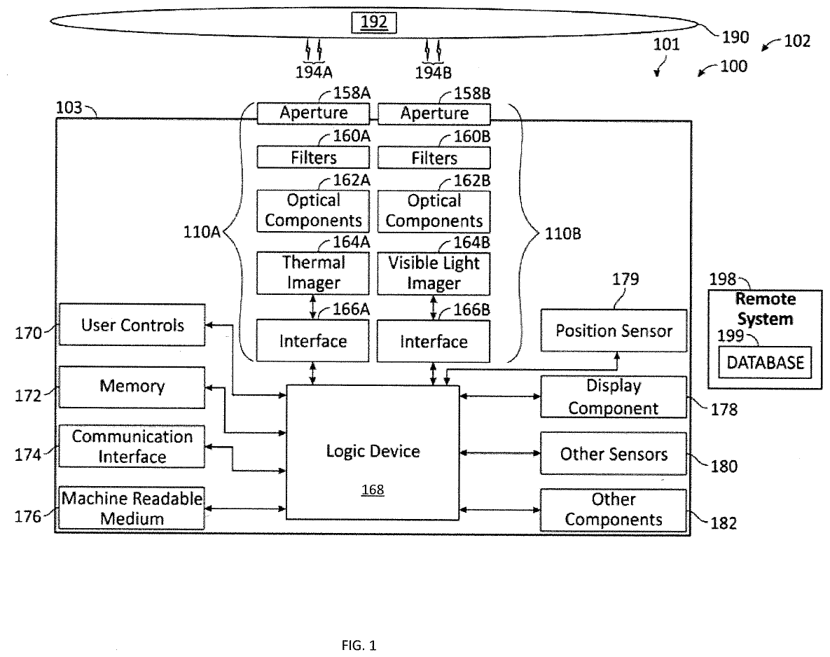

FIG. 1 illustrates a block diagram of an inspection system 100 comprising a portable device 101 and a remote system 198 in accordance with an embodiment of the disclosure. In some embodiments, portable device 101 may be implemented, for example, as a handheld camera system, a small form factor camera system provided as part of part of and/or an attachment to a personal electronic device such as a smartphone, or as another device.

Portable device 101 may be positioned to receive infrared radiation 194A and visible light radiation 194B from a scene 190 (e.g., corresponding to a field of view of portable device 101) in an environment 102 (e.g., a workplace, warehouse, industrial site, manufacturing facility, or other environment). In various embodiments, scene 190 may include one or more physical assets 192 (e.g., temperature-sensitive machines, electronics, or other devices) of interest which may be captured in thermal images and/or visible light images by portable device 101. Although a single example asset 192 is illustrated in FIG. 1, any desired number of assets may be inspected in accordance with the techniques of the present disclosure.

As shown, portable device 101 includes a housing 103 (e.g., a camera body graspable by a user), a thermal imaging subsystem 110A, a visible light imaging subsystem 110B, a logic device 168, user controls 170, a memory 172, a communication interface 174, a machine readable medium 176, a display 178, a position sensor 179, other sensors 180, and other components 182.

Thermal imaging subsystem 110A and visible light imaging subsystem 110B may be used to capture thermal images and visible light images in response to infrared radiation 194A and visible light radiation 194B, respectively, received from a scene 190.

Thermal imaging subsystem 110A may include an aperture 158A, filters 160A, optical components 162A, a thermal imager 164A, and a thermal imager interface 166A. In this regard, infrared radiation 194A passing through aperture 158A may be received by filters 160A that selectively pass particular thermal wavelength ranges (e.g., wavebands) of infrared radiation 194A. Optical components 162A (e.g., an optical assembly including one or more lenses, additional filters, transmissive windows, and/or other optical components) pass the filtered infrared radiation 194A for capture by thermal imager 164A.

Thermal imager 164A may capture thermal images of scene 190 in response to the filtered infrared radiation 194A. Thermal Imager 164A may include an array of sensors (e.g., microbolometers) for capturing thermal images (e.g., thermal image frames) of scene 190. In some embodiments, thermal imager 164A may also include one or more analog-to-digital converters for converting analog signals captured by the sensors into digital data (e.g., pixel values) to provide the captured images. Thermal imager interface 166A provides the captured images to logic device 168 which may be used to process the images, store the original and/or processed images in memory 172, and/or retrieve stored images from memory 172.

Visible light imaging subsystem 110B may include an aperture 158B, filters 160B, optical components 162B, a visible light imager 164B, and a thermal imager interface 166A. It will be appreciated that the various components of visible light imaging subsystem 110B may operate in an analogous manner as corresponding components of thermal imaging subsystem 110A with appropriate technology for capturing visible light images.

Moreover, although particular components are illustrated for each of thermal imaging subsystem 110A and visible light imaging subsystem 110B, it will be understood that the illustrated components are provided for purposes of example. As such, greater or fewer numbers of components may be used in each subsystem as appropriate for particular implementations.

Logic device 168 may include, for example, a microprocessor, a single-core processor, a multi-core processor, a microcontroller, a programmable logic device configured to perform processing operations, a digital signal processing (DSP) device, one or more memories for storing executable instructions (e.g., software, firmware, or other instructions), and/or any other appropriate combinations of devices and/or memory to perform any of the various operations described herein. Logic device 168 is configured to interface and communicate with the various components of portable device 101 to perform various method and processing steps described herein. In various embodiments, processing instructions may be integrated in software and/or hardware as part of logic device 168, or code (e.g., software and/or configuration data) which may be stored in memory 172 and/or a machine readable medium 176. In various embodiments, the instructions stored in memory 172 and/or machine readable medium 176 permit logic device 168 to perform the various operations discussed herein and/or control various components of portable device 101 for such operations.

Memory 172 may include one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, fixed memory, removable memory, and/or other types of memory.

Machine readable medium 176 (e.g., a memory, a hard drive, a compact disk, a digital video disk, or a flash memory) may be a non-transitory machine readable medium storing instructions for execution by logic device 168. When executed, the instructions may cause logic device 168, portable device 101, and/or inspection system 100 to perform actions corresponding with the various functions described elsewhere herein. In various embodiments, machine readable medium 176 may be included as part of portable device 101 and/or separate from portable device 101, with stored instructions provided to portable device 101 by coupling the machine readable medium 176 to portable device 101 and/or by portable device 101 downloading (e.g., via a wired or wireless link) the instructions from the machine readable medium (e.g., containing the non-transitory information).

Logic device 168 may be configured to process captured images and provide them to display 178 for presentation to and viewing by the user. Display 178 may include a display device such as a liquid crystal display (LCD), an organic light-emitting diode (OLED) display, and/or other types of displays as appropriate to display images and/or information to the user of portable device 101. Logic device 168 may be configured to display images and information on display 178. For example, logic device 168 may be configured to retrieve images and information from memory 172 and provide images and information to display 178 for presentation to the user of portable device 101. Display 178 may include display electronics, which may be utilized by logic device 168 to display such images and information.

User controls 170 may include any desired type of user input and/or interface device having one or more user actuated components, such as one or more buttons, slide bars, knobs, keyboards, joysticks, and/or other types of controls that are configured to generate one or more user actuated input control signals. In some embodiments, user controls 170 may be integrated with display 178 as a touchscreen to operate as both user controls 170 and display 178. Logic device 168 may be configured to sense control input signals from user controls 170 and respond to sensed control input signals received therefrom. In some embodiments, portions of display 178 and/or user controls 170 may be implemented by appropriate portions of a tablet, a laptop computer, a desktop computer, and/or other types of devices.

In various embodiments, user controls 170 may be configured to include one or more other user-activated mechanisms to provide various other control operations of portable device 101, such as auto-focus, menu enable and selection, field of view (FoV), brightness, contrast, gain, offset, spatial, temporal, and/or various other features and/or parameters.

Position sensor 179 may be implemented as any appropriate type of device used to determine a position (e.g., location) of portable device 101 in environment 102 (e.g., in an industrial facility containing assets 192 to be monitored). For example, in various embodiments, position sensor 179 may be implemented as a global positioning system (GPS) device, motion sensors (e.g., accelerometers, vibration sensors, gyroscopes, and/or others), depth sensing systems (e.g., time of flight cameras, LiDAR scanners, thermal cameras, visible light cameras, and/or others), antennas, other devices, and/or any combination thereof as desired. In some embodiments, position sensor 179 may send appropriate signals to logic device 168 for processing to determine the absolute and/or relative position of portable device 101 in environment 102.

Portable device 101 may include various types of other sensors 180 including, for example, temperature sensors and/or other sensors as appropriate.

Logic device 168 may be configured to receive and pass images from thermal and visible light imager interfaces 166A-B, additional data from position sensor 179 and sensors 180, and control signal information from user controls 170 to one or more external devices such as remote system 198 through communication interface 174 (e.g., through wired and/or wireless communications). In this regard, communication interface 174 may be implemented to provide wired communication over a cable and/or wireless communication over an antenna. For example, communication interface 174 may include one or more wired or wireless communication components, such as an Ethernet connection, a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components configured for communication with a network. As such, communication interface 174 may include an antenna coupled thereto for wireless communication purposes. In other embodiments, the communication interface 174 may be configured to interface with a DSL (e.g., Digital Subscriber Line) modem, a PSTN (Public Switched Telephone Network) modem, an Ethernet device, and/or various other types of wired and/or wireless network communication devices configured for communication with a network.

In some embodiments, a network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) configured to communicate with other communication networks, such as the Internet. As such, in various embodiments, portable device 101 and/or its individual associated components may be associated with a particular network link such as for example a URL (Uniform Resource Locator), an IP (Internet Protocol) address, and/or a mobile phone number.

Portable device 101 may include various other components 182 such as speakers, displays, visual indicators (e.g., recording indicators), vibration actuators, a battery or other power supply (e.g., rechargeable or otherwise), and/or additional components as appropriate for particular implementations.

Although various features of portable device 101 are illustrated together in FIG. 1, any of the various illustrated components and subcomponents may be implemented in a distributed manner and used remotely from each other as appropriate. For example, remote system 198 may be implemented with any of the various components of portable device 101. Remote system 198 may communicate with portable device 101 to send and receive data therewith, perform remote processing for portable device 101, and/or other tasks (e.g., through appropriate communication interfaces 174 of portable device 101 and/or of remote system 198). For example, in some embodiments, thermal images, visible light images, position data, and/or additional information obtained by portable device 101 may be communicated to remote system 198 for further processing and/or storage. In this regard, remote system 198 may include a database 199 (e.g., maintained in an appropriate memory 172 of remote system 198) used for storage and recall of various images and/or other information to monitor historical temperatures of assets 192. In some environments, remote system 198 may be configured to perform any of the functions described herein with reference to logic device 168.

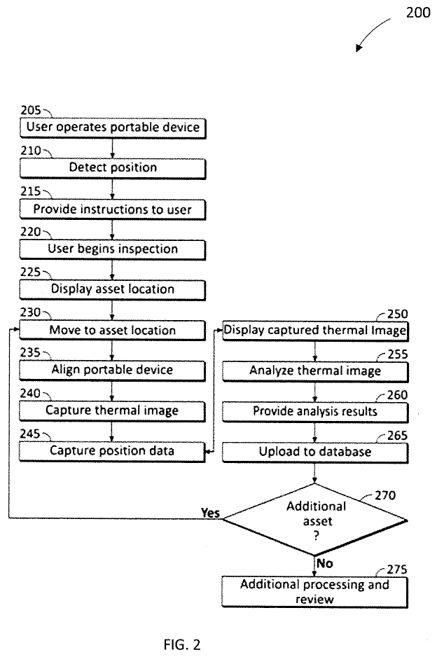

FIG. 2 illustrates a process 200 of monitoring assets 192 in accordance with an embodiment of the disclosure. For example, in some embodiments, the process of FIG. 2 may be performed by a user (e.g., an operator) in connection with portable device 101 and/or remote system 198 to obtain thermal images and/or visible light images of various assets 192 in environment 102. Although various operations of FIG. 2 will be discussed as being performed by portable device 101, such operations may alternatively be performed by remote system 198 and/or both portable device 101 and remote system 198 as appropriate using transfer of thermal images, visible light images, and/or additional information therebetween.

In block 205, the user begins operating portable device 101. For example, in the case of a portable camera system implementation, the user may turn on portable device 101 for operation.

In block 210, portable device 101 detects its current position. For example, in some embodiments, position sensor 179 may detect the current position and provide appropriate signals to logic device 168 to identify and present the current position to the user on display 178. In some embodiments, portable device 101 may detect the current position based on analysis of thermal images and/or visible light images captured in real time as portable device 101 is moved within environment 102 by the user.

Although block 210 is illustrated as a single block, in some embodiments, portable device 101 may repeatedly (e.g., continuously) detect its current position throughout the process of FIG. 2. As a result, portable device 101 may determine is current position on an ongoing basis as the user moves portable device 101 throughout environment 102.

In block 215, portable device 101 obtains and presents asset inspection instructions to the user on display 178. For example, in some embodiments, portable device 101 may be programmed with (or receive from remote system 198) a map, three-dimensional model, checklist, and/or information in another format identifying one or more assets 192 to be measured in environment 102.

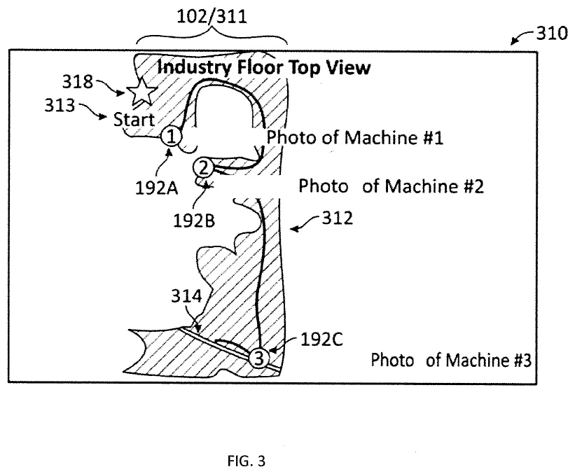

For example, FIG. 3 illustrates asset inspection instructions 310 provided to a user in accordance with an embodiment of the disclosure. As shown in FIG. 3, instructions 310 include a map 311 that provides a top view of environment 102 (e.g., an industrial facility in this embodiment). Map 311 identifies a route 312 that a user may traverse through environment 102 in order to capture thermal images of various assets 192. In particular, route 312 includes a start point 313, an end point 314, and waypoints (e.g., virtual inspection points) corresponding to particular assets 192A, 192B, 192C (identified as Machine #1, Machine #2, and Machine #3, respectively). Although only three assets 192A-C are identified in instructions 310, greater or fewer numbers of assets 192 are contemplated in various embodiments. In some embodiments, instructions 310 may also be searchable by the user to rapidly ascertain particular information as desired.

As discussed with respect to block 210, portable device 101 has detected its position within environment. Accordingly, portable device 101 may further superimpose its current position 318 on instructions 310 as shown in FIG. 3. In addition, portable device 101 may also store position data associated with route 312 and assets 192A-C and may therefore determine its relative position in relation thereto.

In block 220, the user begins (e.g., initiates) an inspection in accordance with instructions 310. For example, the user may select an appropriate user control 170 to acknowledge instructions 310 and begin following them.

In block 225, portable device 101 provides the user with the location of the first asset 192A to be inspected. For example, in some embodiments, portable device 101 may operate one or both of imaging subsystems 110A-B to capture images of environment 102. As a result, portable device 101 may superimpose location information (e.g., graphics, text, and/or other information) on the captured images corresponding to the location of one or more assets 192A-C to display assets 192A-C in an augmented reality format. In various embodiments, portable device 101 may display additional information associated with the assets 192A-C as appropriate. In this regard, portable device 101 may maintain such information locally and/or may receive it from remote system 198.

In some embodiments, portable device 101 displays assets 192A and 192B in an augmented reality format in accordance with an embodiment of the disclosure. In some embodiments, the representation of assets 192A-C may correspond to virtual inspection points (e.g., locations in environment 102 where portable device 101 may be positioned to capture temperature measurements using thermal images. For example, such virtual inspection points may correspond to particular portions of equipment to be inspected (e.g., multiple virtual inspection points may be provided for a single piece of equipment). Thus, it will be appreciated that the physical locations of assets 192A-C may vary from the virtual inspection points (e.g., vantage points of portable device 101) in some embodiments.

In some embodiments, portable device 101 is positioned in environment 102 (e.g., an industrial facility in this embodiment). In addition, display 178 of portable device 101 may present visible light images captured of scene 190 in the environment 102 in real time. In this case, portable device 101 is in proximity to assets 192A and 192B which may be identified through graphics superimposed on the visible light images in an augmented reality format. As a result, the user may easily ascertain the location of assets 192A and 192B as the user traverses route 312 in accordance with instructions 310.

Accordingly, in block 230, the user moves toward the location of the first asset 192A along route 312, translating portable device 101 (e.g., a portable camera system in this embodiment) with the user through environment 102 in order to align a field of view of portable device 101 with asset 192A. Conveniently, the user may be aided by the augmented reality presentation of asset 192A. Moreover, as the user moves toward the location of asset 192A, the augmented reality presentation may be updated as additional images are captured and the position of portable device 101 is updated. For example, in some embodiments, portable device 101 may maintain a three-dimensional model of environment 102 and may track the position of portable device 101 within the three-dimensional model as portable device 101 is moved within environment 102 by the user.

In block 235, the user aligns portable device 101 such that position of portable device 101 is aligned with the location of asset 192A (e.g., the field of view of thermal imaging subsystem 110A corresponds to the virtual inspection point for the location of asset 192A). In this regard, the user may utilize the real time augmented reality presentation of asset 192A to adjust the position of portable device 101 until asset 192A is fully shown on display 178. In some embodiments, portable device 101 may perform MSX processing in block 235 to assist with the user's alignment of portable device 101 in relation to one or more assets 192 (e.g., to provide a guide outline overlaid on a visible light image) to assist the user with alignment. In some embodiments, portable device 101 may provide tactile, audible, and/or visual feedback to guide the user in aligning portable device 101. In some embodiments, portable device 101 does not perform processing to assist with the user's alignment.

In some embodiments, the augmented reality presentation of asset 192A may be fully contained within the borders of display 178. In addition, the precise physical location of asset 192A within the augmented reality graphic may be further identified on display 178. Thus, it will be appreciated that portable device 101 is now sufficiently aligned to capture one or more thermal images of asset 192A, for example, for temperature monitoring purposes. In some embodiments, portable device 101 may verify the alignment with asset 192A by capturing and analyzing appropriate thermal or visible light images. For example, portable device 101 may capture one or more thermal or visible light images of asset 192A and indicate to the user when sufficient data has been gathered.

In some embodiments, various settings of portable device 101 may be set automatically for thermal or visible light image capture (e.g., integration time, shutter speed, and/or other settings) based on the detected position of thermal portable device 101. In some embodiments, specific thermal settings may be set for different parts of thermal images (e.g., different emissivity settings for different locations) and various thermal measurement operations may be set (e.g., spot, box, and line measurements in the thermal images). In various embodiments, any of these settings may be predefined and/or may be set using previous measurements as templates. As a result, images captured of asset 192A may be effectively captured with high precision.

In block 240, after the alignment is performed, portable device 101 captures a thermal image of asset 192A using thermal imaging subsystem 110A. In block 245, portable device 101 may capture position data identifying the position of portable device 101 at the time of thermal image capture. In some embodiments, block 245 may be performed during (e.g., simultaneously or in close temporal proximity to) block 240. Additional information such as time and/or other information may also be captured in block 245 as desired. As a result, portable device 101 and/or remote system 198 may store the captured thermal image, one or more temperature information (e.g., measurements) extracted from the thermal image, and/or additional information (e.g., position, time, and/or other information) associated with the thermal image capture to provide an inspection record of asset 192A.

In some embodiments, the thermal image is captured in response to identifying target landmark points based on stored reference landmark points. As discussed in further detail below, reference landmark points correspond with pixel locations in a reference image of reference landmark features. In some embodiments, portable device 101 processes images corresponding with its field of view, and, in response to identifying target landmark points, captures the thermal image. In some embodiments, as the portable device 101 is moved along the route, the portable device 101 is continuously scanning images corresponding with a substantially current field of view to identify target landmark points. The identified target landmark features are identified as corresponding with the regions of the processed images that have the same or similar or corresponding distinguishing properties as the distinguishing properties of the reference image which correspond with the reference landmark features. Accordingly, portable device 101 may be configured to identify target assets well moving with respect to the target assets.

In some embodiments, block 245 may include recording the position (e.g., spatial position in x, y, z coordinates or otherwise) and time associated with each pixel in the captured thermal image. As a result, the temperature associated with each pixel may be mapped in a multi-dimensional representation of environment 102 as further discussed herein.

In some embodiments, block 240 and/or 245 may be performed automatically by portable device 101 (e.g., triggered by logic device 168) after logic device 168 detects that thermal imager 164A is aligned with asset 192A, for example, based on a detected position of portable device 101, analysis of one or more real time thermal or visible light images captured of asset 192A, and/or otherwise. In some embodiments, block 240 and/or 245 may be performed by portable device 101 in response to the user's operation of one or more user controls 170.

In block 250, portable device 101 may present the captured thermal image on display 178 for the user's review. In some embodiments, portable device transmits data of the thermal image to remote system 198.

In block 255, portable device 101 or remote system 198 analyzes the captured thermal image 320. Such analysis may include, for example, extraction of temperature information from thermal image 320 (e.g., temperatures associated with one or more pixels of thermal image 320) and comparing such information to expected temperature ranges and/or historical temperature data. For example, in various embodiments, the thermal image 320 may processed such that different points in space can be graphed or trended, images can be compared visually to a baseline and can be processed by appropriate machine learning processes.

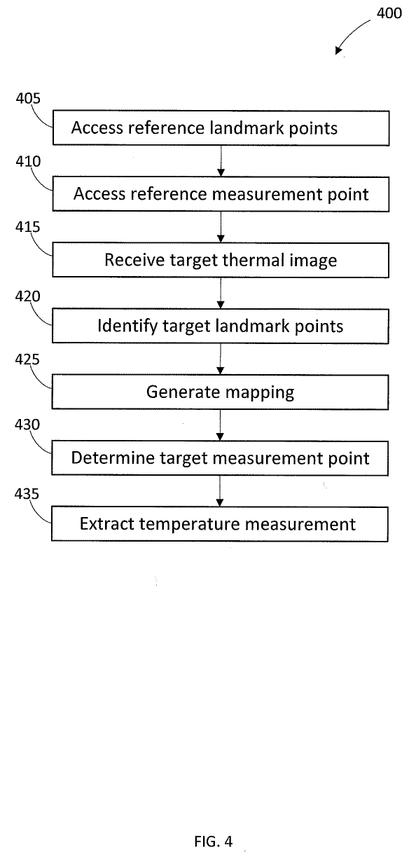

In some embodiments, the analysis of block 255 may include comparison of the captured thermal image 320 with previously captured thermal and/or visible light images of asset 192A to determine whether asset 192A was accurately captured. In some embodiments, the analysis of block 255 may include aspects of the method discussed below with reference to FIG. 4.

In some embodiments, remote system 198 transmits results of the analysis to portable device 101.

In block 260, portable device 101 may provide the results of the analysis to the user on display 178. For example, in some embodiments, portable device 101 may display temperature information associated with asset 192A extracted from thermal image 320.

In some embodiments, portable device 101 may further display historical temperature data associated with asset 192A to permit the user to rapidly determine whether the current temperature is within normal or expected historical temperature ranges (e.g., while portable device 101 is positioned at the location of asset 192A). For example, portable device 101 may present historical temperature readings 330 and a current temperature reading 332 associated with asset 192A on display 178 in accordance with an embodiment of the disclosure. Also in block 260, if the temperature associated with asset 192A is outside of an expected range, portable device 101 may display one or more notifications (e.g., warnings, alerts, and/or other information) as appropriate to inform the user of the same. In some embodiments, such information may be presented to the user in an augmented reality format.

In block 265, portable device 101 may upload the captured thermal image 320, position data, time, and/or other information to remote system 198 for storage and further processing.

In block 270, portable device 101 may determine whether any additional assets 192 remain to be inspected. For example, in the scenario discussed above, asset 192A has been inspected but assets 192B and 192C remain to be inspected. In this case, the process returns to block 230 where the user moves to the location of the next asset (e.g., asset 192B) along route 312. After all assets have been inspected, the process continues to block 275 where additional analysis may be performed, for example, as further discussed herein.

Although the process of FIG. 2 has been discussed primarily in relation to the capture of thermal images by thermal imaging subsystem 110A, the process may also include the capture of visible light images of assets 192 by visible light imaging subsystem 110B. For example, in some embodiments, a visible light image may also be captured in block 240 during (e.g., simultaneously with or in close temporal proximity to) the capture of the thermal image. In this regard, portable device 101 may capture both thermal and visible light images of the same asset 192 at the same (or close to the same) time. The visible light image may be similarly displayed, analyzed, and/or uploaded where appropriate in a similar manner as discussed with regard to the thermal image. As a result, in some embodiments, remote system 198 may be provided with both thermal and visible light images corresponding to the same asset 192 for additional analysis as further discussed herein.

FIG. 4 illustrates a process 400 of determining a target measurement point according to some embodiments. The operations of process 400 may be performed, for example, by one or more of logic device 168, portable device 101, remote system 198, and/or inspection system 100. In some embodiments, process 400 is performed as part of process 200, for example, at block 255.

At block 405, reference landmark points are accessed. For example, the reference landmark points may have been previously generated for a reference image, where the reference landmark points correspond with pixel locations in the reference image of landmark features. The landmark features may correspond with regions of the image that have certain distinguishing properties. For example, landmark features may correspond with image structures in the image, such as points, edges, shapes, or objects. For example, landmark features may be selected by an image processing system using a general neighborhood operation and/or a feature detection process applied to the image. Some landmark features may be defined as or with respect to curves or boundaries between different image regions. The landmark features may have characteristics of features, for example, as known to those of skill in the art of computer vision, pattern recognition, and/or image processing.

In some cases, pixel locations of one or more of the landmark features is selected by an image processing system performing a feature identification algorithm. In some embodiments, the landmark features are identified by a trained artificial intelligence system. In some cases, the pixel locations of one or more of the landmark features is selected based on inputs received from a user, where the inputs identify the pixel locations. In some embodiments, the pixel locations are selected from a visible light image or a thermal image.

In some embodiments, process 400 further includes generating the reference landmark points, for example, using techniques described above and/or other techniques.

At block 410, one or more reference measurement points are accessed. For example, the reference measurement points may have been previously generated for the reference image, where the reference measurement points correspond with pixel locations in the reference image representing assets or portions of assets to be measured.

In some cases, pixel locations of one or more of the reference measurement points is selected by an image processing system, for example, selecting measurement points corresponding with assets or portions of assets having characteristic values of the aspect being measured, such as maximum or minimum temperatures, temperatures greater than a threshold, and temperatures less than a threshold. In some embodiments, the pixel locations of one or more of the reference measurement points is selected by a trained artificial intelligence system. In some cases, the pixel locations of one or more of the reference measurement points is selected based on inputs received from a user, where the inputs identify the pixel locations.

In some embodiments, process 400 further includes generating the reference measurement points, for example, using techniques described above and/or other techniques.

At block 415, data representing a target image is received. For example, thermal image data, such as that captured at block 240 of process 200 may be received. In some embodiments, the target image is a visible light image or a thermal image.

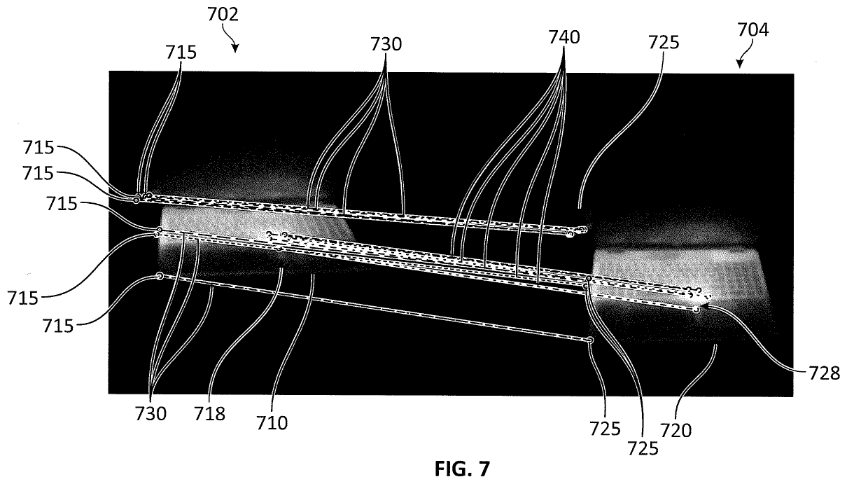

At block 420, target landmark points are identified in the target image received at block 415. For example, processing the target image may identify the target landmark features as those features corresponding with the regions of the target image that have the same or similar or corresponding distinguishing properties as the distinguishing properties of the reference image which correspond with the reference landmark features. In some embodiments, the target landmark points are identified by a trained artificial intelligence system. Embodiments of methods of identifying target landmark points are discussed below with reference to FIG. 7.

At block 425, a mapping, such as a transformation mapping or a matrix transformation mapping is generated. In some embodiments, the mapping is generated in response to the target landmark points being identified at block 420. For example, based on pixel locations of each reference landmark point and its corresponding target landmark point, a number of mapping vectors maybe calculated. In some environments, the mapping vectors form the generated mapping or form a part of the generated mapping. Embodiments of methods of generating a mapping are discussed below with reference to FIG. 7.

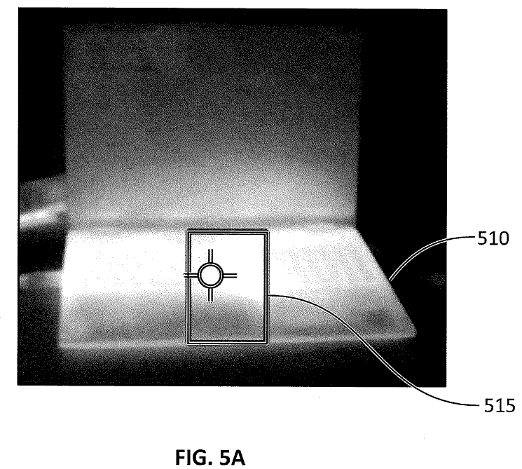

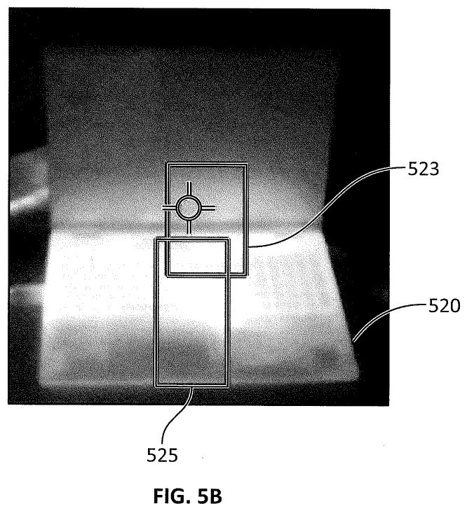

At block 430, one or more target measurement points are determined. In some embodiments, the target measurement points are determined in response to the target landmark points being identified at block 420 and the mapping being generated at block 425. For example, based on the mapping generated at block 425, and based on the pixel location(s) of the one or more reference measurement points, the one or more target measurement points are determined. In some embodiments, the target measurement points are identified by a trained artificial intelligence system. Embodiments of methods of determining the one or more target measurement points are discussed below with reference to FIG. 7. FIGS. 5A and 5B graphically illustrate an embodiment of target measurement points determined based on reference measurement points and a mapping.

At block 435, one or more temperature measurements of the asset are extracted. In some embodiments, the temperature measurements are extracted in response to the target measurement points being determined. In some environments, a single target measurement point is identified as a measurement tool. In some embodiments, multiple measurement points are collectively identified as a single measurement tool. In some environments, multiple sets of measurement points are identified as multiple measurement tools. In some embodiments, the temperature measurement is extracted for each identified measurement tool. For example, a temperature measurement process having features similar or identical to those discussed above with reference to block 255 of process 200 may be used to extract the temperature measurement. Other processes may be used.

As discussed, pixel locations may be selected from a visible light image or a thermal image, the reference image may be a visible light image or a thermal image, and the target image may be a visible light image or a thermal image. In this regard, although various thermal images are discussed in the present disclosure, it is contemplated that visible light images and/or thermal images may be used as appropriate. For example, in some embodiments, reference landmark points and target landmark points may be identified using visible light images and applied to measurement points on thermal images.

FIGS. 5A and 5B graphically illustrate an embodiment of target measurement points being determined based on reference measurement points and a mapping. FIG. 5A illustrates a reference image of a reference asset 510 having a reference measurement tool 515 according to some embodiments. In some embodiments, the reference image is a visible light image or a thermal image. FIG. 5B illustrates a target thermal image of a target asset 520 having a target measurement tool 525 according to some embodiments.

In the illustrated embodiment, the pixel locations of the reference measurement tool 515 of reference asset 510 correspond with reference measurement points. In some embodiments, the reference measurement points are selected based on inputs received from a user, where the inputs identify the pixel locations. In some embodiments, reference measurement points may be selected algorithmically, for example, based on the temperature measurements of various points on the asset.

Rectangle 523, illustrated in FIG. 5B, is positioned in the target thermal image at pixel locations which are the same as the pixel locations of the reference measurement tool 515 in the reference image. As illustrated, the portion of target asset 520 encompassed by rectangle 523 is different from the portion of reference asset 510 encompassed by reference measurement tool 515.

In contrast, the portion of target asset 520 encompassed by target measurement tool 525 in the target thermal image is the same, or substantially the same, as the portion of reference asset 510 encompassed by reference measurement tool 515 in the reference image. Accordingly, a temperature measurement based on the position of target measurement tool 525 represents an asset temperature of the portion of target asset 520 which corresponds with the portion of reference asset 510 encompassed by reference measurement tool 515.

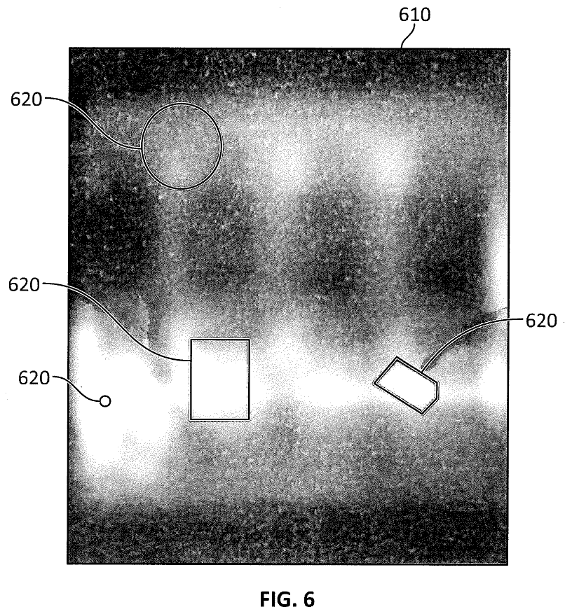

FIG. 6 illustrates a thermal image of a portion of an asset 610 having a plurality of measurement tools 620, according to some embodiments. As illustrated, the geometry of measurement tools may vary. In the illustrated embodiment, measurement tools having a circular, rectangle, and polygonal perimeter are shown. In addition, a measurement tool having a single measurement point is shown. The geometry of the measurement tools is not limited.

FIG. 7 illustrates a reference image 702 having a reference asset 710 with reference landmark points 715 and reference measurement points 718 indicated. FIG. 7 also illustrates a target thermal image 704 having a target asset 720 with target landmark points 725 and target measurement points 728 indicated. FIG. 7 further illustrates a plurality of mapping vector conceptual representations 730 and a plurality of transformation vector conceptual representations 740, according to some embodiments.

In some embodiments, reference asset 710 and target asset 720 are physically the same asset, for example, at different times, and/or from different points of view. In some embodiments, reference asset 710 and target asset 720 are physically different assets. In some embodiments, reference asset 710 and target asset 720 are different instances of the same, or substantially the same, asset.

Reference landmark points 715 are placed to correspond with pixel locations in the reference image 702 of landmark features of reference asset 710. Reference landmark features may be selected, for example, by an image processing system using a general neighborhood operation and/or a feature detection process applied to the reference image 702.

Target landmark points 725 are placed to correspond with pixel locations in the target thermal image 704 of corresponding landmark features of target asset 720. Target landmark features may be selected, for example, by an image processing system using a general neighborhood operation and/or a feature detection process applied to the target thermal image 704.

Each mapping vector conceptual representation 730 extends from a particular reference landmark point 715 in reference image 702 to a particular corresponding target landmark point 725 in target thermal image 704, and represents a difference in the pixel location of the particular reference landmark point 715 and the pixel location of the particular corresponding target landmark point 725. Mapping vectors to be used for determining transformation vectors, discussed in further detail below, may be calculated based on differences in the pixel locations of the reference landmark points 715 in reference image 702 and the pixel locations of the target landmark points 725 in target thermal image 704. Accordingly, the mapping vectors each have a distance characteristic corresponding with a distance (e.g., in pixels) separating the pixel location of the particular reference landmark point 715 in reference image 702 and the pixel location of the particular corresponding target landmark point 725 in target thermal image 704. Furthermore, each mapping vector may have a direction characteristic corresponding with an angle or direction (in the pixel space) from the pixel location of the particular reference landmark point 715 in reference image 702 and the pixel location of the particular corresponding target landmark point 725 in target thermal image 704.

Each transformation vector conceptual representation 740 extends from a particular reference measurement point 718 to a particular corresponding target measurement point 728, and represents a difference in the pixel location of the particular reference measurement point 718 in reference image 702 and the pixel location of the particular corresponding target measurement point 728 in target thermal image 704. A transformation matrix to be used for determining target measurement points, discussed in further detail below, may be calculated based on the pixel locations of the reference measurement points 718 and the mapping vectors. The transformation matrix is used to either literally or effectively calculate transformation vectors which may each have a distance characteristic corresponding with a distance (e.g., in pixels) separating the pixel location of the particular reference measurement point 718 in reference image 702 and the pixel location of the particular corresponding target measurement point 728 in target thermal image 704. Furthermore, each transformation vector may have a direction characteristic corresponding with an angle or direction (in the pixel space) from the pixel location of the particular reference measurement point 718 in reference image 702 and the pixel location of the particular corresponding target measurement point 728 in target thermal image 704. The pixel locations of the target measurement points 728 are determined based on the pixel locations of the reference measurement points 718 and the calculated transformation vectors.

In some embodiments, to calculate transformation vectors, the mapping vectors are used to calculate a transformation matrix, such as a projective matrix, for example, a homography matrix. The parameter estimation of the a transformation matrix can use, for example, RANdom Sample Consensus (RANSAC), for example, to filter out outliers in the estimation. The transformation matrix may be used to calculate pixel locations for each target measurement point. Accordingly, the pixel locations of the target measurement points 728 are determined based on the pixel locations of the reference measurement points 718 and the transformation matrix.

In some embodiments, to calculate transformation vectors, the mapping vectors are used to calculate a transformation vectors mapping the pixel location of each reference measurement point 718 to the pixel location of the corresponding target measurement points 728.

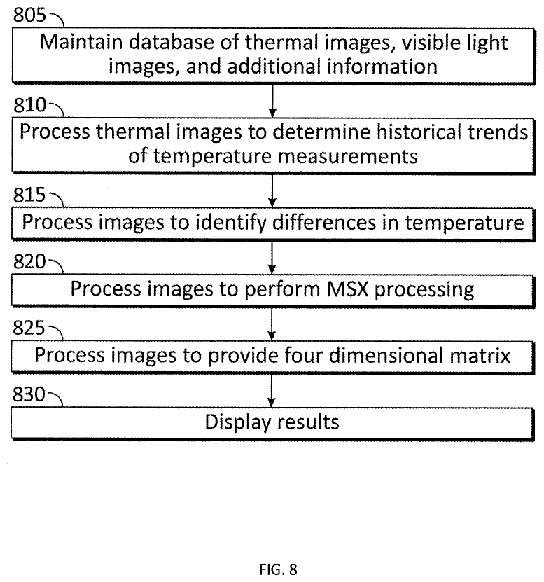

FIG. 8 illustrates a process of performing additional analysis on information stored in database 199 of remote system 198 for one or more assets in accordance with an embodiment of the disclosure. For example, the process of FIG. 8 may be performed in block 275 of FIG. 2. In some embodiments, some or all of the process of FIG. 8 is performed by portable device 101.

In block 805, remote system 198 maintains database 199 of thermal images, visible light images, and/or other information associated with one or more assets 192 as discussed. For example, database 199 may include various information for asset 192A including: descriptive and status information for the equipment associated with asset 192A, historical temperature readings, current temperature readings, recent thermal images, previous thermal images, user comments, and additional previous thermal images with their associated alert conditions. Additional information (e.g., position information, time, visible light images, and/or other information) may also be stored as appropriate.

Blocks 810 to 825 identify various processing that may be performed on the information in database 199, for example, in response to user queries provided to remote system 198. Although particular processing is illustrated in a sequential manner, this is only for purposes of example and any desired processing may be performed in any desired order. Moreover, although such processing is primarily discussed as being performed by remote system 198, any or all of the operations discussed in FIG. 8 may be performed by portable device 101, remote system 198, and/or distributed therebetween.

In block 810, at least one thermal image is processed to extract temperature measurements and determine historical temperature trends.

In block 815, a recent thermal image is processed in relation to one or more previous thermal images to identify one or more differences in temperature over the one or more previous thermal images. As a result, the processed version of the recent thermal image may be conveniently reviewed to easily ascertain recent changes in temperature associated with asset 192A.

In block 820, one or more thermal images are processed in relation to one or more visible light images (e.g., captured as previously discussed) to generate a combined image comprising thermal image content and visible light image content. In some embodiments, the processing performed in block 820 may include any of the various techniques set forth in U.S. Pat. Nos. 8,520,970, 8,565,547, 8,749,635, 9,171,361, 9,635,285, and/or 10,091,839, all of which are hereby incorporated by reference in their entirety. In some embodiments, such processing may include, for example, contrast enhancement processing (e.g., also referred to as MSX processing, high contrast processing, and/or fusion processing), true color processing, triple fusion processing, alpha blending, and/or other processing as appropriate.

As discussed, block 245 may include the recording of the position and time associated with each pixel of a captured thermal image. Accordingly, in block 825, one or more thermal images are processed to provide a four-dimensional (three-dimensional space and time) matrix representation of temperatures associated with any of assets 192A-C. As a result, the temperature associated with each pixel may be mapped and reviewed in a four-dimensional environment.

In block 830, the results of the processing of blocks 810 to 825 are displayed by portable device 101 and/or remote system 198.

In view of the present disclosure, it will be appreciated that the various techniques provided herein permit temperature measurements to be performed conveniently by a user of a low-cost portable device 101 without requiring extensive hardware sensors or related equipment. In addition, such techniques do not require significant training of the user. For example, appropriate processing and artificial intelligence may be implemented in portable device 101 and/or remote system 198 to provide targeting applications for unique use cases that lower the threshold of instruction and education required to use thermal imaging.

In some embodiments, the augmented reality format provided to the user may be customized for particular use cases. In addition, the instructions 310 provided to the user may interact with high precision indoor navigation techniques (e.g., provided by position sensor 179) and appropriate navigation processes for natural navigation by the user through environment 102.

While thermal images are specifically discussed herein, the aspects discussed may also be similarly or identically applied to IR images, visible light images, or images of any light spectrum.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method, comprising:
accessing a plurality of reference landmark points associated with a plurality of features in a reference image;
accessing a reference measurement point corresponding to an asset in the reference image;
receiving a target image comprising the features and the asset;
identifying a plurality of target landmark points of the target image corresponding to the features;
generating a mapping from the reference landmark points to the target landmark points;
determining, using the mapping, a target measurement point corresponding to the asset in the target image; and
extracting, from the target measurement point of the target image, a temperature measurement of the asset.

2. The method of claim 1, further comprising processing the reference image to determine the reference landmark points.

3. The method of claim 1, further comprising:
receiving an input identifying the reference landmark points; and
receiving an input identifying the reference measurement point.

4. The method of claim 1, wherein the mapping is generated based on a plurality of mapping vectors that map pixel locations of the reference landmark points in the reference image to pixel locations of the target landmark points in the target image.

5. The method of claim 1, wherein the reference image depicts the asset captured from a first point of view and the target image depicts the asset captured from a second point of view, wherein the mapping transforms the reference measurement point in the first point of view to the target measurement point in the second point of view.

6. The method of claim 5, wherein the mapping comprises a homography matrix.

7. The method of claim 1, further comprising:
processing the target image to identify the target landmark points; and
generating the mapping and determining the target measurement point in response to identifying the target landmark points.

8. The method of claim 7, further comprising capturing the target image while moving with respect to the asset, wherein the target image is processed in response to the capturing.

9. The method of claim 1, further comprising:
accessing one or more additional reference measurement points corresponding to the asset in the reference image;
determining, using the mapping, one or more additional target measurement points corresponding to the asset in the target image; and
extracting, from the one or more additional target measurement points of the target image, one or more additional temperature measurements of the asset.

10. The method of claim 1, further comprising capturing the target image as one of a plurality of target images captured along a route.

11. A system, comprising:
a thermal imager;
a display; and
a logic device configured to:
access a plurality of reference landmark points associated with a plurality of features in a reference image,
access a reference measurement point corresponding to an asset in the reference image,
receive a target image comprising the features and the asset,
identify a plurality of target landmark points of the target image corresponding to the features,
generate a mapping from the reference landmark points to the target landmark points,
determine, using the mapping, a target measurement point corresponding to the asset in the target image, and
extract, from the target measurement point of the target image, a temperature measurement of the asset.

12. The system of claim 11, wherein the logic device is further configured to process the reference image to determine the reference landmark points.

13. The system of claim 11, wherein the logic device is further configured to receive an input identifying the reference landmark points, and to receive an input identifying the reference measurement point.

14. The system of claim 11, wherein the mapping is generated based on a plurality of mapping vectors that map pixel locations of the reference landmark points in the reference image to pixel locations of the target landmark points in the target image.

15. The system of claim 11, wherein the reference image depicts the asset captured from a first point of view and the target image depicts the asset captured from a second point of view, wherein the mapping transforms the reference measurement point in the first point of view to the target measurement point in the second point of view.

16. The method of claim 15, wherein the mapping comprises a homography matrix.

17. The system of claim 11, wherein the logic device is further configured to:
process the target image to identify the target landmark points; and
generate the mapping and determining the target measurement point in response to identifying the target landmark points.

18. The system of claim 17, wherein the logic device is further configured to capture the target image while moving with respect to the asset, wherein the target image is processed in response to the capturing.

19. The system of claim 11, wherein the logic device is further configured to:
access one or more additional reference measurement points corresponding to the asset in the reference image;
determine, using the mapping, one or more additional target measurement points corresponding to the asset in the target image; and
extract, from the one or more additional target measurement points of the target image, one or more additional temperature measurements of the asset.

20. The system of claim 11, wherein the logic device is further configured to capture the target image as one of a plurality of target images captured along a route.
